(19) United States
(12) Patent Application Publication
(10) Pub. No.: US 2009/0080063 A1
(43) Pub. Date: Mar. 26, 2009

(54) ARRAY WAVEGUIDE AND LIGHT SOURCE USING THE SAME

(75) Inventors: Tze Chia Lin, Hsinchu (TW); Tso Lun Wu, Hsinchu (TW); Shang Ling Liu, Hsinchu (TW); Ming Hsien Chou, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: HC PHOTONICS CORP., Hsinchu (TW)

(21) Appl. No.: 11/859,666

(22) Filed: Sep. 21, 2007

(51) Int. Cl. G02F 1/365

(52) U.S. Cl. 359/332

(57) ABSTRACT

A light source comprises a light-emitting module configured to emit a first beam and an array waveguide configured to convert the first beam into a second beam. The light-emitting module includes a plurality of light-emitting units configured to emit the first beam, and the light-emitting units are positioned in an array manner. The array waveguide includes a ferroelectric crystal with a first polarization direction, a plurality of inverted domains positioned in the ferroelectric crystal and a plurality of wavelength-converting waveguides positioned in the ferroelectric crystal. The inverted domains have a second polarization direction substantially opposite to the first polarization direction, the wavelength-converting waveguides cross the inverted domains substantially in a perpendicular manner, and the inverted domains are configured to convert the first beam from the light-emitting module into second beam as the first beams propagate through the wavelength-converting waveguides.

### BACKGROUND OF THE INVENTION

(A) Field of the Invention

The present invention relates to an array waveguide and a light source using the same, and more particularly, to an array waveguide having a plurality of wavelength-converting waveguides and a light source using the same.

(B) Description of the Related Art

The poled structure having periodically inverted domains in a ferroelectric single crystal such as lithium niobate (LiNbO₃), lithium tantalite (LiTaO₃) and potassium titanyl phosphate (KTiOPO₄) may be widely used in the optical fields such as optical storage and optical measurement. There are several methods for preparing the poled structure such as the proton-exchanging method, the electron beam-scanning method, the electric voltage applying method, etc.

U.S. Pat. No. 6,002,515 discloses a method for manufacturing a polarization inversion part on a ferroelectric crystal substrate. The polarization inversion part is prepared by steps of applying a voltage in the polarization direction of the ferroelectric crystal substrate to form a polarization inversion part, conducting a heat treatment for reducing an internal electric field generated in the substrate by the applied voltage, and then reinverting polarization in a part of the polarization inversion part by applying a reverse direction voltage against the voltage that was previously applied. In other words, the method for preparing a polarization inversion part disclosed in U.S. Pat. No. 6,002,515 requires performing the application of electric voltage twice.

U.S. Pat. No. 7,170,671 discloses a method for forming a waveguide region within a periodically domain reversed ferroelectric crystal wherein the waveguide region has a refractive index profile that is vertically and horizontally symmetric. The symmetric profile produces effective overlapping between quasi-phasematched waves, a corresponding high rate of energy transfer between the waves and a symmetric cross-section of the radiated wave. The symmetric refractive index profile is produced by a method that combines the use of a diluted proton exchange medium at a high temperature which produces a region of high index relatively deeply beneath the crystal surface, followed by a reversed proton exchange which restores the original crystal index of refraction immediately beneath the crystal surface.

U.S. Pat. No. 6,353,495 discloses a method for forming an optical waveguide element. The disclosed method forms a convex ridge portion having a concave portion on a ferroelectric single crystalline substrate, and a ferroelectric single crystalline film is then formed in the concave portion. A comb-shaped electrode and a uniform electrode are formed on a main surface of the ferroelectric single crystalline substrate, and electric voltage is applied to these two electrodes to form a ferroelectric domain-inverted structure in the film in the concave portion.

U.S. Pat. No. 6,404,797 discloses an array arrangement of several laser devices. A one- or two-dimensional array of surface emitting laser devices are formed in a first semiconductor substrate, a corresponding one- or two-dimensional array of micro-reflectors are formed on a second semiconductor substrate, and an optional nonlinear material may be positioned between the first and second substrate for frequency selection. Positions of the surface emitting laser devices and the micro-reflectors on respective semiconductor substrates are precisely defined so that each surface emitting laser device may be accurately coupled to a corresponding micro-reflector respectively when both substrates are coupled together.

### SUMMARY OF THE INVENTION

One aspect of the present invention provides an array waveguide having a plurality of wavelength-converting waveguides and a light source using the same.

An array waveguide according to this aspect of the present invention comprises a ferroelectric crystal with a first polarization direction, a plurality of inverted domains positioned in the ferroelectric crystal and a plurality of wavelength-converting waveguides positioned in the ferroelectric crystal. The inverted domains have a second polarization direction substantially opposite to the first polarization direction, the wavelength-converting waveguides cross the inverted domains substantially in a perpendicular manner, and the inverted domains are configured to convert the first beam from the light-emitting module into a second beam as the first beam propagates through the wavelength-converting waveguides.

Another aspect of the present invention provides a light source comprising a light-emitting module configured to emit a first beam and an array waveguide configured to convert the first beam into a second beam. The light-emitting module includes a plurality of light-emitting units configured to emit the first beam, and the light-emitting units are positioned in an array manner. The array waveguide includes a ferroelectric crystal with a first polarization direction, a plurality of inverted domains positioned in the ferroelectric crystal and a plurality of wavelength-converting waveguides positioned in the ferroelectric crystal. The inverted domains have a second polarization direction substantially opposite to the first polarization direction, the wavelength-converting waveguides cross the inverted domains substantially in a perpendicular manner, and the inverted domains are configured to convert the first beam from the light-emitting module into the second beam as the first beam propagates through the wavelength-converting waveguides.

### BRIEF DESCRIPTION OF THE DRAWINGS

The objectives and advantages of the present invention will become apparent upon reading the following description and upon reference to the accompanying drawings in which:

FIG. 1 illustrates a light source according to one embodiment of the present invention;

FIG. 2 illustrates a light source according to another embodiment of the present invention;

FIG. 3 illustrates an array waveguide according to another embodiment of the present invention;

FIG. 4 illustrates an array waveguide according to another embodiment of the present invention;

FIG. 5 illustrates an array waveguide according to another embodiment of the present invention;

FIG. 6 illustrates an array waveguide according to another embodiment of the present invention;

FIG. 7 illustrates an array waveguide according to another embodiment of the present invention; and

FIG. 8 illustrates an array waveguide according to another embodiment of the present invention.

### DETAILED DESCRIPTION OF THE INVENTION

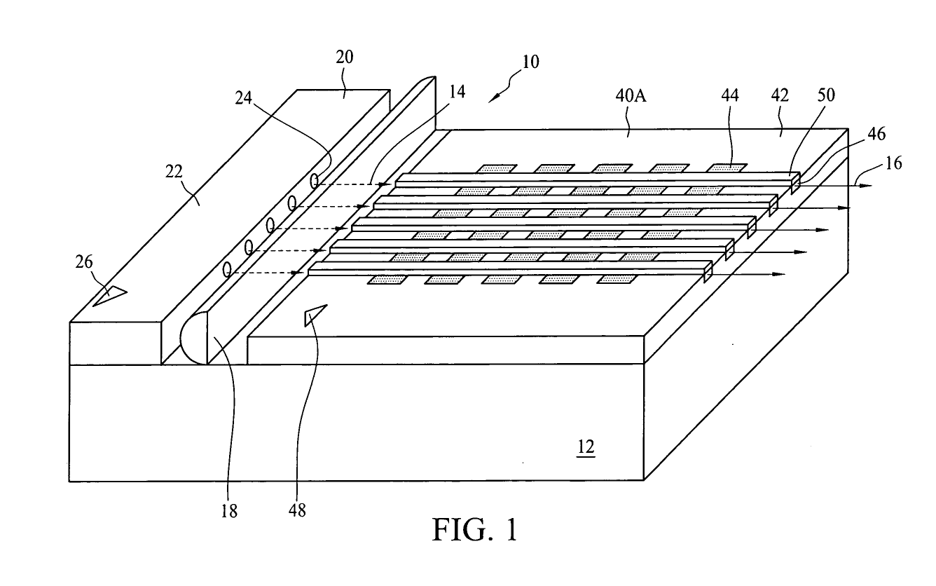

FIG. 1 illustrates a light source 10 according to one embodiment of the present invention. The light source 10 comprises a substrate 12 such as a silicon submount or cupper (Cu) submount, a light-emitting module 20 positioned on the substrate 12 and configured to emit a first beam 14 having a first wavelength, and an array waveguide 40A positioned on the substrate 12 and configured to convert the first beam 14 into a second beam 16 having a second wavelength preferably shorter than the first wavelength. The light-emitting module 20 includes a substrate 22 and a plurality of light-emitting units 24 configured to emit the first beam 14. The light-emitting module 20 can be an array of vertical cavity surface emitting layers (VCSEL), and light-emitting units 24 are preferably lasers positioned in an array manner. In addition, the light source 10 may further comprises a mode-matching member 18 such as a semi-circular pillar or a lens set configured to coupling the first beam 14 from the light-emitting module 20 into the array waveguide 40A.

The array waveguide 40A includes a ferroelectric crystal 42 with a first polarization direction, a plurality of inverted domains 44 positioned in the ferroelectric crystal 42, a plurality of wavelength-converting waveguides 46 positioned in the ferroelectric crystal 42, and a plurality of stripes 50 positioned right on the wavelength-converting waveguides 46. In particular, the refractive index of the stripes 50 is higher than that of the wavelength-converting waveguides 46. The inverted domains 44 have a second polarization direction substantially opposite to the first polarization direction, the wavelength-converting waveguides 46 cross the inverted domains 44 substantially in a perpendicular manner, and the inverted domains 44 are configured to convert the first beam 14 from the light-emitting module 20 into the second beam 16 as the first beam 14 propagates through the wavelength-converting waveguides 46. Preferably, the substrate 22 has a first alignment key 26, and the ferroelectric crystal 42 has a second alignment key 48.

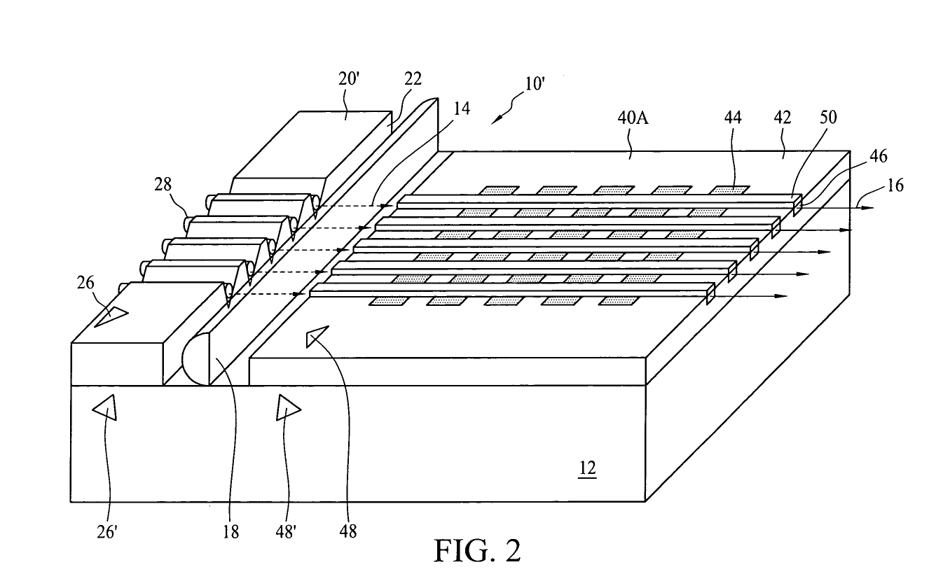

FIG. 2 illustrates a light source 10′ according to another embodiment of the present invention. Compared with the light source 10 in FIG. 1, the light source 10′ uses a light-emitting module 20′, a plurality of lasers configured to emit the first beam 14 and a plurality of fibers 28 configured to transmit the first beam 14 from the lasers to the wavelength-converting waveguides 46 in the ferroelectric crystal 42. Preferably, the substrate 22 of the light-emitting module 20′ includes V-shaped grooves 30, and the fibers 28 are positioned in the grooves 30. In particular, the substrate 12 also includes an alignment key 26′ for aligning with the first alignment key 26 of the light-emitting module 20′ and alignment key 48′ for aligning with the second alignment key 48 of the array waveguide 40A.

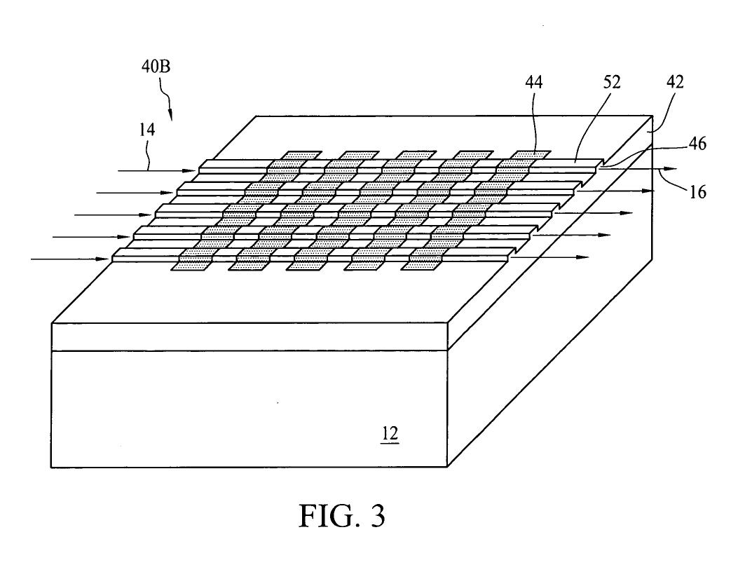

FIG. 3 illustrates an array waveguide 40B according to another embodiment of the present invention. Compared with the array waveguide 40A in FIG. 1, the ferroelectric crystal 42 of the array waveguide 40B includes a plurality of stripe-shaped ridges 52 and the wavelength-converting waveguides 46 are positioned in the stripe-shaped ridges 52. In particular, since the refractive index of the stripe-shaped ridges 52 is higher than that of the exterior, i.e., the environment, the stripe-shaped ridges 52 function as the waveguide.

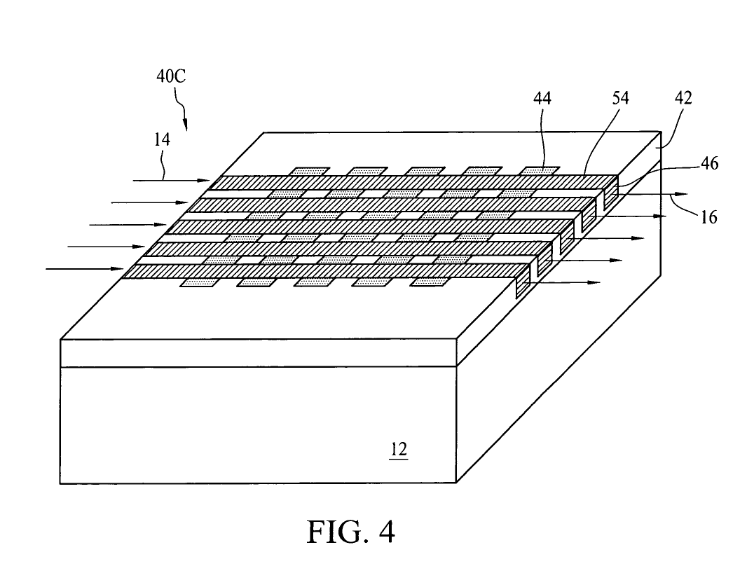

FIG. 4 illustrates an array waveguide 40C according to another embodiment of the present invention. Compared with the array waveguide 40A in FIG. 1, the wavelength-converting waveguides 46 of the array waveguide 40C are guiding stripes 54 in the ferroelectric crystal 42, and the refractive index of the guiding stripes 54 is higher than that of the ferroelectric crystal 42. The guiding stripes 54 might be formed by chemical diffusion or exchange process such as proton-exchange process or titanium-diffusion process.

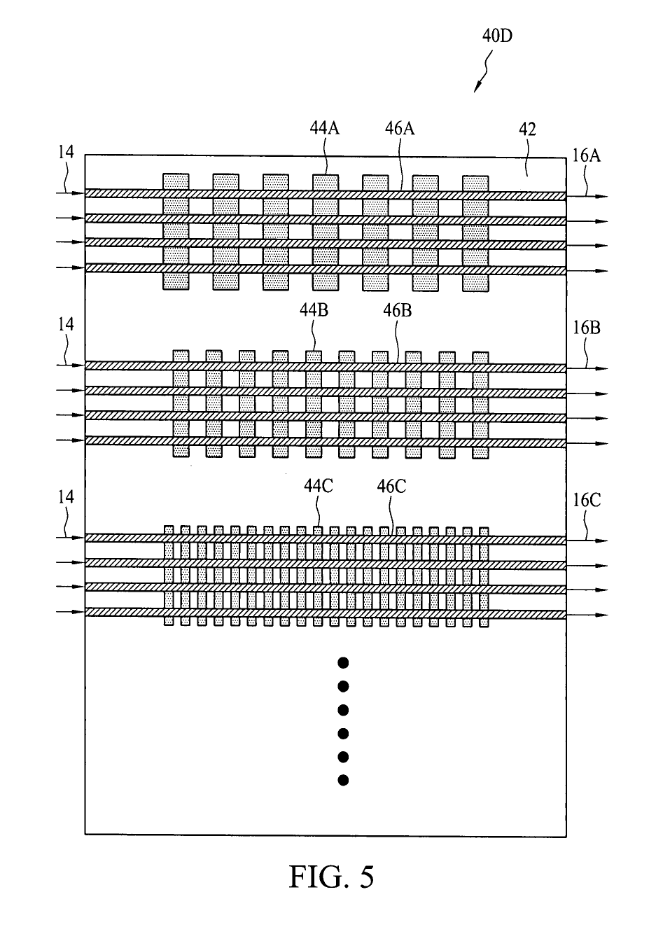

FIG. 5 illustrates an array waveguide 40D according to another embodiment of the present invention. The inverted domains 44 of array waveguide 40D includes at least a plurality of first inverted domains 44A with a first period in the ferroelectric crystal 42, a plurality of second inverted domains 44B with a second period in the ferroelectric crystal 42 and a plurality of third inverted domains 44C with a third period in the ferroelectric crystal 42. In addition, the wavelength-converting waveguides 46 of the array waveguide 40D includes several first wavelength-converting waveguide 46A crossing the first inverted domains 44A, several second wavelength-converting waveguide 46B crossing the second inverted domains 44B and several third wavelength-converting waveguide 46C crossing the third inverted domains 44C.

In particular, the first inverted domains 44A and the first wavelength-converting waveguide 46A are used to convert the first beam 14 from the light-emitting module 20 into the red light 16A, the second inverted domains 44B and the second wavelength-converting waveguide 46B are used to convert the first beam 14 from the light-emitting module 20 into the green light 16B, and the third inverted domains 44C and the third wavelength-converting waveguide 46C are used to convert the first beam 14 from the light-emitting module 20 into the blue light 16C.

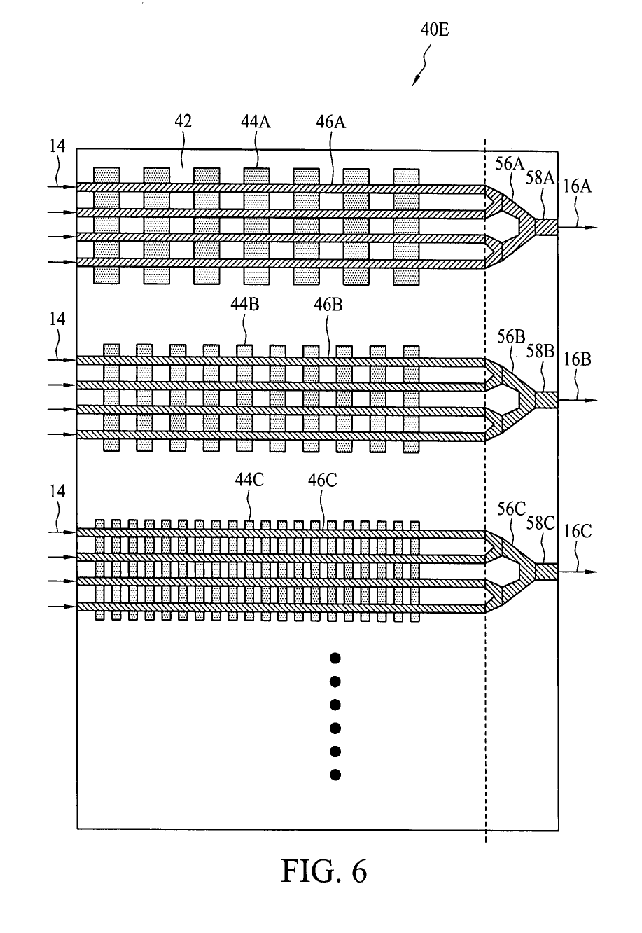

FIG. 6 illustrates an array waveguide 40E according to another embodiment of the present invention. Compared with the array waveguide 40D in FIG. 5, the array waveguide 40E further comprises at least a first output-coupling waveguide 56A configured to couple several first wavelength-converting waveguides 46A with a first output waveguide 58A, a second output-coupling waveguide 56B configured to couple several second wavelength-converting waveguides 46B with a second output waveguide 58B and a third output-coupling waveguide 56C configured to couple several third wavelength-converting waveguides 46C with a third output waveguide 58C. By using these output-coupling waveguides 56A, 56B and 56C to couple the beams from several wavelength-converting waveguides 46A, 46B and 46C into the respective single output waveguide 58A, 58B and 58C, the array waveguide 40E can be used to provide the light beams 16A, 16B and 16C with high power.

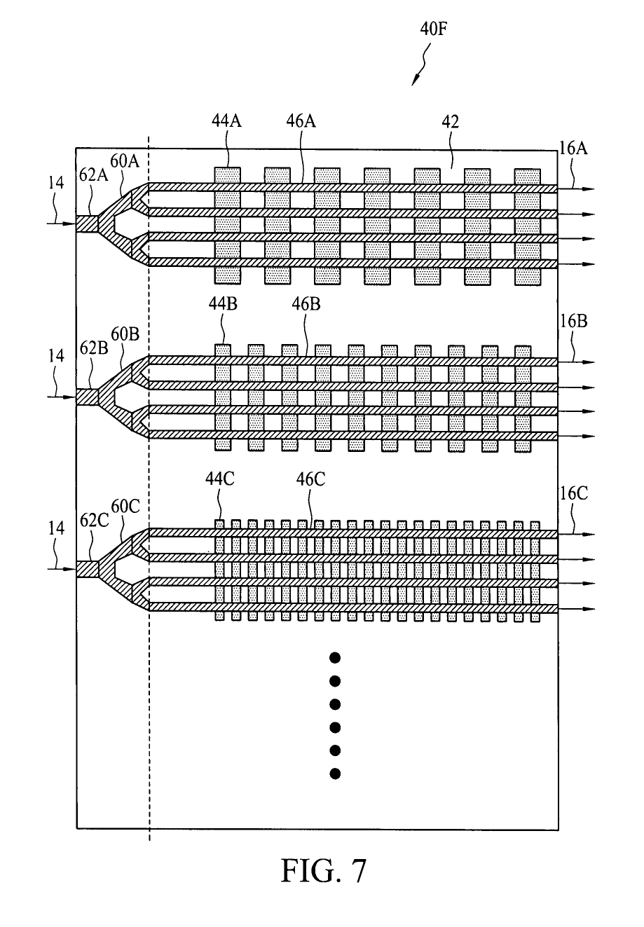

FIG. 7 illustrates an array waveguide 40F according to another embodiment of the present invention. Compared with the array waveguide 40D in FIG. 5, the array waveguide 40F further comprises at least a first input-coupling waveguide 60A configured to couple a first input waveguide 62A with several first wavelength-converting waveguides 46A, a second input-coupling waveguide 60B configured to couple a second input waveguide 62B with several second wavelength-converting waveguides 46B, and a third input-coupling waveguide 60C configured to couple a third input waveguide 62C with several third wavelength-converting waveguides 46C. By using these input-coupling waveguides 60A, 60B and 60C to split the first beam 14 with high intensity and high power from the light-emitting module 20 into several wavelength-converting waveguides 46A, 46B and 46C, the array waveguide 40F can prevent the occurrence of crystal damage due to the high intensity and high power of the first beam 14 from the light-emitting module 20.

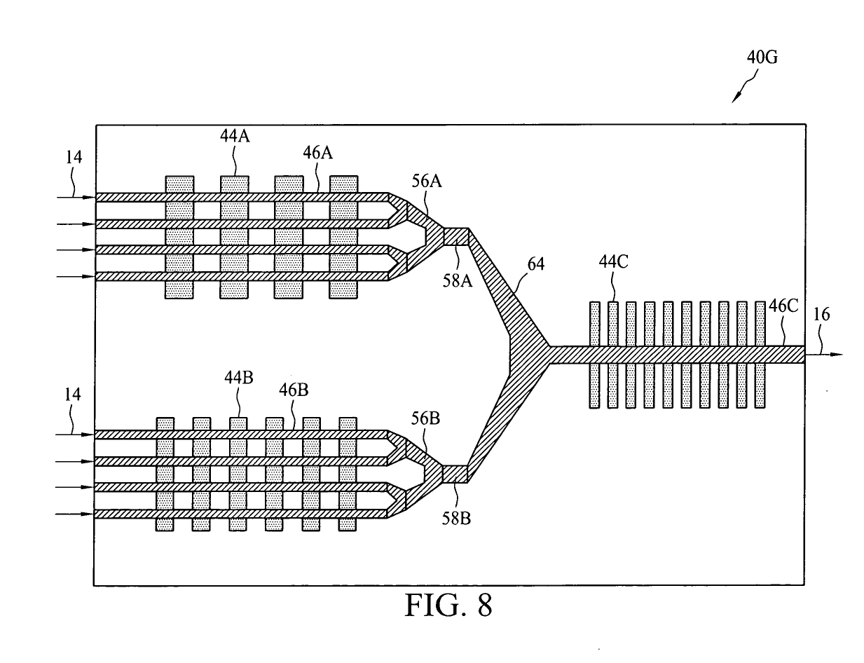

FIG. 8 illustrates an array waveguide 40G according to another embodiment of the present invention. The array waveguide 40G comprises an output-coupling waveguide 64 configured to couple the first wavelength-converting waveguide 46A and the second wavelength-converting waveguide 46B with the third wavelength-converting waveguide 46C. The array waveguide 40G can be used to convert the first beam 14 from the light-emitting module 20 into the second beam 16 by the sum frequency generation (SFG) mechanism.

The above-described embodiments of the present invention are intended to be illustrative only. Numerous alternative embodiments may be devised by those skilled in the art without departing from the scope of the following claims.

What is claimed is:

1. An array waveguide, comprising:
a ferroelectric crystal with a first polarization direction;
a plurality of inverted domains positioned in the ferroelectric crystal, the inverted domains having a second polarization direction substantially opposite to the first polarization direction; and
a plurality of wavelength-converting waveguides positioned in the ferroelectric crystal, the wavelength-converting waveguides crossing the inverted domains substantially in a perpendicular manner;
wherein the inverted domains are configured to convert a first beam into a second beam as the first beam propagates through the wavelength-converting waveguides.

2. The array waveguide as claimed in claim 1, further comprising a plurality of stripes positioned on the wavelength-converting waveguides, and the refractive index of the stripes is higher than that of the wavelength-converting waveguides.

3. The array waveguide as claimed in claim 1, wherein the ferroelectric crystal includes a plurality of stripe-shaped ridges and the wavelength-converting waveguides are positioned in the stripe-shaped ridges.

4. The array waveguide as claimed in claim 1, wherein the wavelength-converting waveguides are guiding stripes in the ferroelectric crystal, and the refractive index of the guiding stripes is higher than that of the ferroelectric crystal.

5. The array waveguide as claimed in claim 1, further comprising at least one output-coupling waveguide configured to couple at least two wavelength-converting waveguides with an output waveguide.

6. The array waveguide as claimed in claim 1, further comprising at least one input-coupling waveguide configured to couple an input waveguide with at least two wavelength-converting waveguides.

7. The array waveguide as claimed in claim 1, wherein the inverted domains include at least:
a plurality of first inverted domains with a first period in the ferroelectric crystal;
a plurality of second inverted domains with a second period in the ferroelectric crystal; and
a plurality of third inverted domains with a third period in the ferroelectric crystal.

8. The array waveguide as claimed in claim 7, wherein the wavelength-converting waveguides include at least one first wavelength-converting waveguide crossing the first inverted domains, at least one second wavelength-converting waveguide crossing the second 15 inverted domains and at least one third wavelength-converting waveguide crossing the third inverted domains.

9. The array waveguide as claimed in claim 8, further comprising:
a first output-coupling waveguide configured to couple at least two first wavelength-converting waveguides with a first output waveguide;
a second output-coupling waveguide configured to couple at least two second wavelength-converting waveguides with a second output waveguide; and
a third output-coupling waveguide configured to couple at least two third wavelength-converting waveguides with a third output waveguide.

10. The array waveguide as claimed in claim 8, further comprising:
a first input-coupling waveguide configured to couple a first input waveguide with at least two first wavelength-converting waveguides;
input waveguide with at least two second wavelength-converting waveguides; and
a third output-coupling waveguide configured to couple a third input waveguide with at least two third wavelength-converting waveguides.

11. The array waveguide as claimed in claim 8, further comprising an output-coupling waveguide configured to couple the first wavelength-converting waveguide and the second wavelength-converting waveguide with the third wavelength-converting waveguide.

12. A light source, comprising:
a light-emitting module including a plurality of light-emitting units configured to emit first beams, the light-emitting units being positioned in an array manner; and
an array waveguide including:
a ferroelectric crystal with a first polarization direction;
a plurality of inverted domains positioned in the ferroelectric crystal, the inverted domains having a second polarization direction substantially opposite to the first polarization direction;
a plurality of wavelength-converting waveguides positioned in the ferroelectric crystal, the wavelength-converting waveguides crossing the inverted domains substantially in a perpendicular manner; and
wherein the inverted domains are configured to convert the first beams from the light-emitting module into second beams as the first beams propagate through the wavelength-converting waveguides.

13. The light source as claimed in claim 12, wherein the light-emitting module includes a substrate, and the light-emitting units are lasers positioned on the substrate.

14. The light source as claimed in claim 12, wherein the light-emitting units include:
a plurality of lasers configured to emit the first beams; and
a plurality of fibers configured to transmit the first beams from the lasers to the wavelength-converting waveguides.

15. The light source as claimed in claim 14, wherein the light-emitting module includes a substrate with grooves, and the fibers are positioned in the grooves.

16. The light source as claimed in claim 12, wherein the light-emitting module includes a substrate and the light-emitting units are positioned on the substrate, the substrate has a first alignment key, and the ferroelectric crystal has a second alignment key.

17. The light source as claimed in claim 12, wherein the array waveguide further comprises a plurality of stripes positioned on the wavelength-converting waveguides, and the refractive index of the stripes is higher than that of the wavelength-converting waveguides.

18. The light source as claimed in claim 12, wherein the ferroelectric crystal includes a plurality of stripe-shaped ridges and the wavelength-converting waveguides are positioned in the stripe-shaped ridges.

19. The light source as claimed in claim 12, wherein the wavelength-converting waveguides are guiding stripes in the ferroelectric crystal, and the refractive index of the guiding stripes is higher than that of the ferroelectric crystal.

20. The light source as claimed in claim 12, wherein the array waveguide further comprises at least one output-coupling waveguide configured to couple at least two wavelength-converting waveguides with an output waveguide.

21. The light source as claimed in claim 12, wherein the array waveguide further comprises at least one input-coupling waveguide configured to couple an input waveguide with at least two wavelength-converting waveguides.

22. The light source as claimed in claim 12, wherein the inverted domains include at least:
a plurality of first inverted domains with a first period in the ferroelectric crystal;
a plurality of second inverted domains with a second period in the ferroelectric crystal; and
a plurality of third inverted domains with a third period in the ferroelectric crystal.

23. The light source as claimed in claim 22, wherein the wavelength-converting waveguides include at least one first wavelength-converting waveguide crossing the first inverted domains, at least one second wavelength-converting waveguide crossing the second inverted domains and at least one third wavelength-converting waveguide crossing the third inverted domains.

24. The light source as claimed in claim 23, wherein the array waveguide further comprises:
a first output-coupling waveguide configured to couple at least two first wavelength-converting waveguides with a first output waveguide;
a second output-coupling waveguide configured to couple at least two second wavelength-converting waveguides with a second output waveguide; and
a third output-coupling waveguide configured to couple at least two third wavelength-converting waveguides with a third output waveguide.

25. The light source as claimed in claim 23, wherein the array waveguide further comprises:
a first input-coupling waveguide configured to couple a first beam from a first input waveguide with at least two first wavelength-converting waveguides;
a second input-coupling waveguide configured to couple a second input waveguide with at least two second wavelength-converting waveguides; and
a third input-coupling waveguide configured to couple a third input waveguide with at least two third wavelength-converting waveguides.

26. The light source as claimed in claim 23, wherein the array waveguide further comprises an output-coupling waveguide configured to couple the first wavelength-converting waveguide and the second wavelength-converting waveguide with the third wavelength-converting waveguide.
